(19) United States
(12) Patent Application Publication
(10) Pub. No.: US 2024/0187160 A1
(43) Pub. Date: Jun. 6, 2024

(54) METHODS FOR ENABLING CARRIER SWITCHING FOR UPLINK CONTROL INFORMATION

(71) Applicant: INTERDIGITAL PATENT HOLDINGS, INC., Wilmington, DE (US)

(72) Inventors: Aata El Hamss, Laval (CA); Patrick Tooher, Montreal (CA); Paul Marinier, Brossard (CA); Faris Alfarhan, Montreal (CA)

(73) Assignee: INTERDIGITAL PATENT HOLDINGS, INC., Wilmington, DE (US)

(21) Appl. No.: 18/285,100

(22) PCT Filed: Mar. 30, 2022
(86) PCT No.: PCT/US2022/022543

§ 371 Date: Sep. 29, 2023

Related U.S. Application Data
(60) Provisional application No. 63/167,863, filed on Mar. 30, 2021.
(60) Provisional application No. 63/249,435, filed on Sep. 28, 2021.

(51) Int. Cl. H04L 5/00; H04W 72/21; H04W 72/23; H04W 72/56

(52) U.S. Cl. CPC H04L 5/0048; H04W 72/21; H04W 72/23; H04W 72/56

(57) ABSTRACT

In one or more embodiments, there may be one or more devices, methods, and/or systems addressing or relating to carrier switching for sending uplink control information. In one case, a wireless transmit receive unit (WTRU) may have more than one uplink channel carrier available. The WTRU may determine, or be instructed, which carrier(s) to use in the event that a first carrier cannot be used. The WTRU may receive configuration information that may assist in determining which carrier to use.

### CROSS-REFERENCE TO RELATED APPLICATIONS

This application claims the benefit of U.S. Provisional Application No. 63/167,863, filed Mar. 30, 2021, and No. 63/249,435 Sep. 28, 2021, the contents of which are incorporated herein by reference.

### BACKGROUND

In modern wireless systems, a wireless device may need to communicate as efficiently as possible with a network to achieve the performance of new and upcoming use cases. In one example, it may be desirable for devices in the future to communicate with very low latency. To achieve new use case performance goals, there is a need for novel and improved approaches to wireless systems.

### SUMMARY

In one or more embodiments, there may be one or more devices, methods, and/or systems addressing or relating to carrier switching for sending uplink transmission(s). In one case, a wireless transmit receive unit (WTRU) may have more than one uplink channel carrier available. The WTRU may determine, or be instructed, which carrier(s) to use in the event that a first carrier cannot be used. The WTRU may receive configuration information that may assist in determining which carrier to use.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of carrier aggregation with 2 TDD cells;

FIG. 3 illustrates an example of PUCCH carrier switching for HARQ-ACK transmission;

FIG. 4 illustrates an example of a PUCCH carrier associate with a time pattern configuration;

FIG. 5 illustrates an example of switching uplink carriers based on a condition;

FIG. 6 illustrates an example of switching uplink carriers based on a condition;

FIG. 7 illustrates an example of switching uplink carriers based on a dropping/cancelation; and

FIG. 8 is a diagram illustrating an example of switching carriers.

### DETAILED DESCRIPTION

As described herein, one or more of the following abbreviations and/or acronyms may be used: Acknowledgement (ACK); Block Error Rate (BLER); Bandwidth Part (BWP); Configured Grant (CG); Cancellation Indication (CI); Control Resource Set (CORESET); Cyclic Prefix (CP); Conventional OFDM (relying on cyclic prefix) (CP-OFDM); Channel Quality Indicator (CQI); Cyclic Redundancy Check (CRC); Channel State Information (CSI); Downlink Assignment Index (DAI); Downlink Control Information (DCI); Dynamic Grant (DG); Downlink feedback information (DFI); Downlink (DL); Demodulation Reference Signal (DM-RS); Flexible (FL); Hybrid Automatic Repeat Request (HARQ); License Assisted Access (LAA); Listen-Before-Talk (LBT); Long Term Evolution (LTE); MAC control element (MAC CE); Modulation and Coding Scheme (MCS); Multiple Input Multiple Output (MIMO); Negative ACK (NACK); New Radio (NR); Orthogonal Frequency-Division Multiplexing (OFDM); Physical Layer (PHY); Physical Random Access Channel (PRACH); Primary Synchronization Signal (PSS); Physical Uplink Control Channel (PUCCH); Random Access Channel (or procedure) (RACH); Random Access Response (RAR); Radio access network Central Unit (RCU); Radio Front end (RF); Radio Link Failure (RLF); Radio Link Monitoring (RLM); Radio Network Identifier (RNTI); Radio Resource Control (RRC); Radio Resource Management (RRM); Reference Signal (RS); Reference Signal Received Power (RSRP); Received Signal Strength Indicator (RSSI); Service Data Unit (SDU); Semi-Persistent Scheduling (SPS); Scheduling Request (SR); Sounding Reference Signal (SRS); Secondary Synchronization Signal (SSS); Semi-persistent scheduling (SPS); Transport Block (TB); Transport Block Size (TBS); Transmission/Reception Point (TRP); Uplink (UL); Uplink Control Information (UCI); Ultra-Reliable and Low Latency Communications (URLLC).

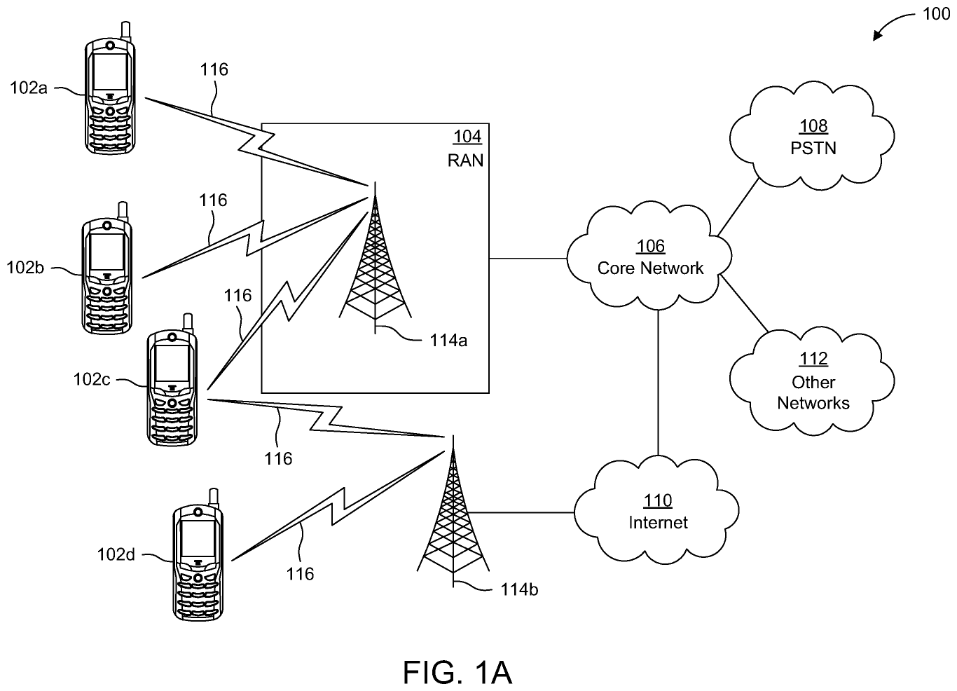

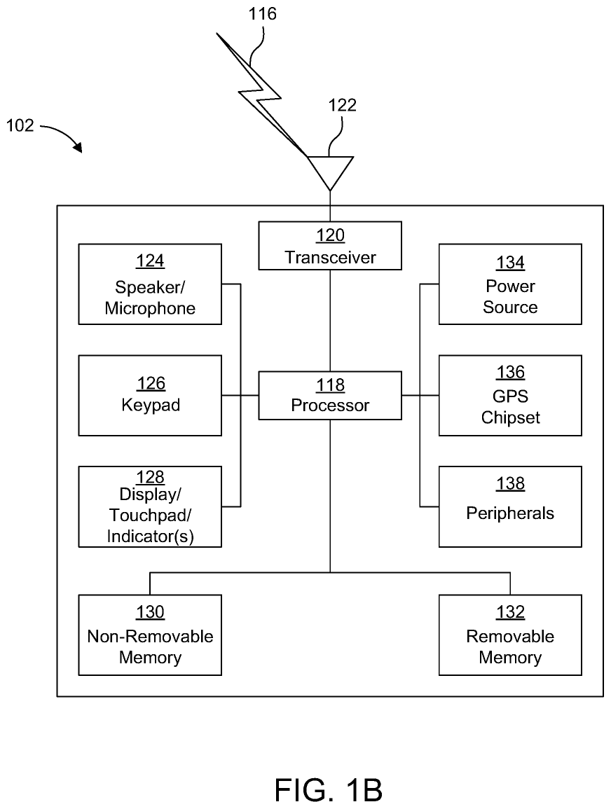

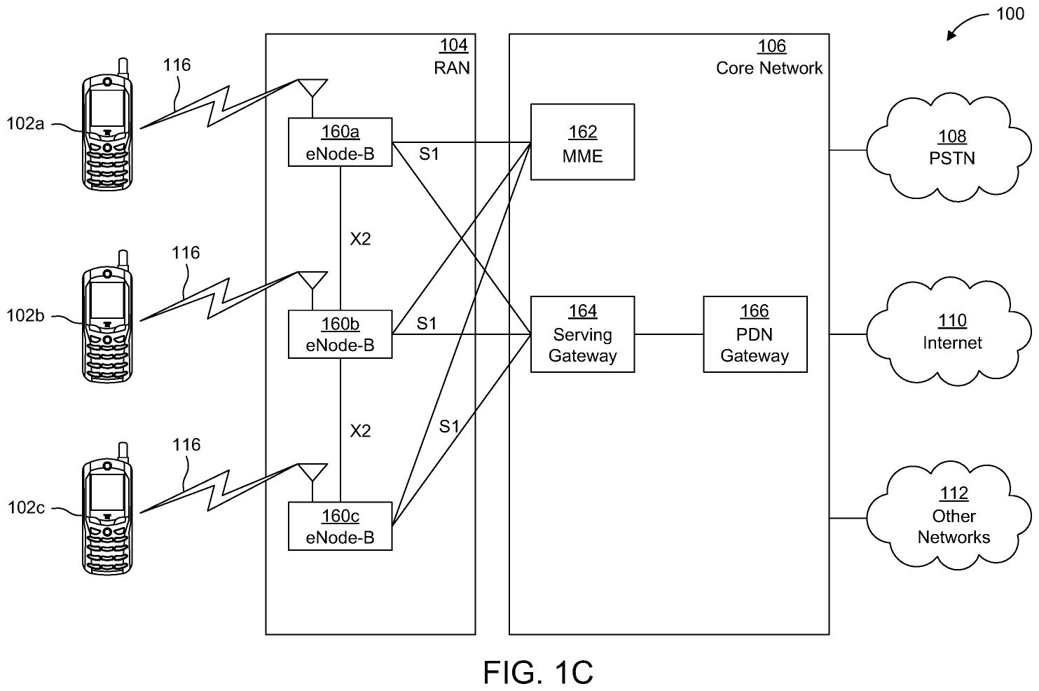

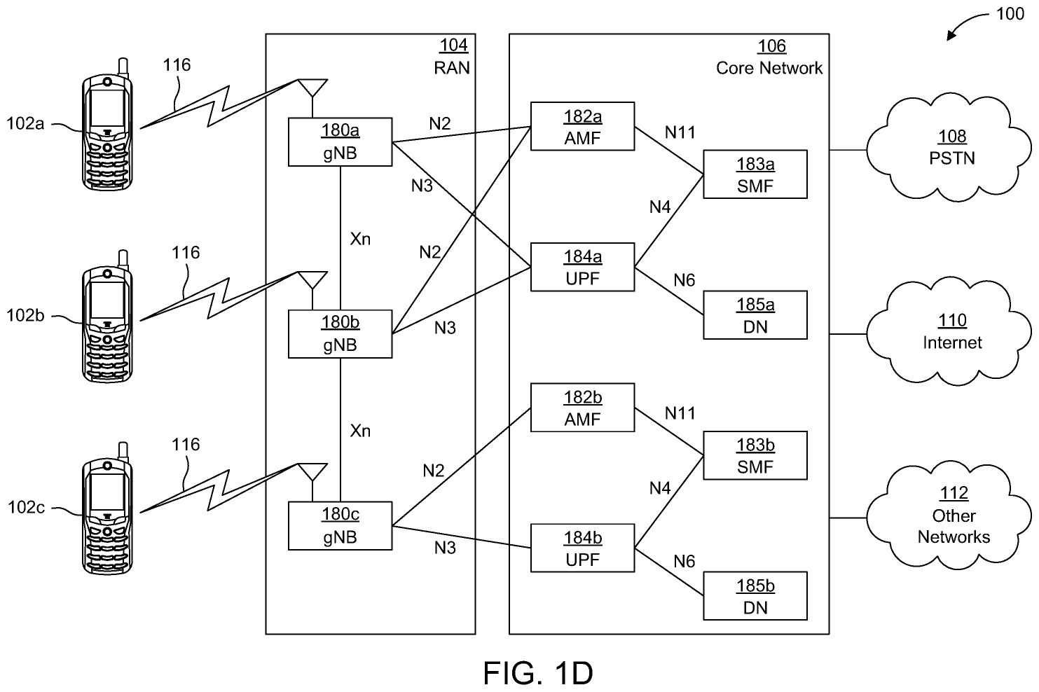

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE. One or more WTRUs may be configured to transmit and/or receive wireless signals on one or more carrier frequencies, which may be referred to as a cell (not shown).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for wireless service to a specific geographical area that may be relatively fixed, or that may change over time. The cell may further be divided into cell sectors. For example, the cell associated with base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHZ. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c). As discussed herein, physical uplink control channel (PUCCH) carrier is an example of an uplink (UL) carrier, and may be used interchangeably.

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In any one of the examples shown in FIGS. 1A-1D, a WTRU may transmit in a TDD mode of operation where the uplink and downlink are multiplexed in the time domain, and where the WTRU may suffer from additional latency due to unavailable uplink opportunities to send a transmission (e.g., uplink control information (UCI), HARQ ACK feedback, etc.). Under some conditions (e.g., inter-band case) in carrier aggregation, the WTRU may have two TDD carriers with different UL/DL configuration. In some cases, the carrier configured for uplink transmission (e.g., PUCCH) for a set of carriers may be semi-statically fixed. In an example, a WTRU may need to wait for an uplink slot (e.g., on a PUCCH cell) to acknowledge a downlink transport block (TB) that it received, which may add latency to the exchange. An earlier uplink opportunity may be available using an alternative carrier, and may help reduce the latency to meet a target performance.

Generally, in a TDD scenario a carrier may have both downlink and/or uplink opportunities, but for illustration purposes as discussed herein they may be referred to as carriers for what they are being used for, such as PUCCH carrier(s) and/or PDSCH carrier(s), even though they may refer to the same carrier. Further, the term PUCCH carrier may refer to the carrier on which a PUCCH transmission is sent, and the PDSCH carrier may refer to the carrier on which a PDSCH transmission is sent, but depending on the case, there may be some or no overlap of these carriers. Additionally, as disclosed herein slot and symbol are interchangeable unless otherwise specified.

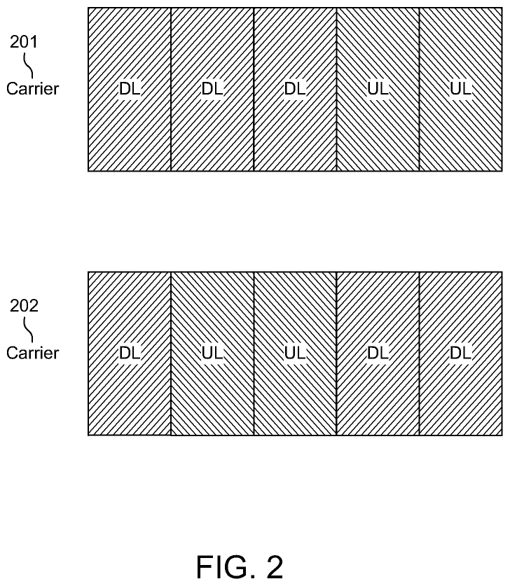

FIG. 2 illustrates an example of carrier aggregation with two TDD carriers. As shown, there is carrier 201 that has a first UL/DL configuration, and carrier 202 that has a second UL/DL configuration. As mentioned, with a TDD mode of operation, the WTRU may suffer from additional latency due to unavailable uplink opportunities to transmit uplink control information (UCI). For example, assuming that only carrier 201 is used, if the WTRU receives a downlink assignment in a first slot of carrier 201, then in the best-case scenario the HARQ ACK feedback may be transmitted by the WTRU in the fourth slot. If the HARQ-ACK feedback is negative, then the base station (e.g., gNB) may need to schedule a retransmission and may need to wait again for HARQ-ACK feedback. Aggregating a second carrier, such as carrier 202, may enable an earlier HARQ-ACK transmission opportunity under some conditions. For example, in an inter-band carrier aggregation case, the WTRU may have two TDD carriers with different UL/DL configurations as shown. If the above example is reconsidered, but assumptions are made that both carriers 201 and 202 can be used, then an earlier uplink opportunity may exist in the second slot of carrier 202.

In some cases, for NR systems, the carrier configured for PUCCH transmission for a set of downlink carriers may be semi-statically fixed. In order to help reduce the latency and meet target performance goals, an earlier uplink opportunity may be enabled in a dynamic manner to change the uplink carrier.

For dynamic uplink carrier switching, the WTRU may be pre-configured with two uplink carriers and may use a first uplink carrier by default. The base station may send a DCI indicating to change to a second uplink carrier in order to utilize an earlier uplink slot (e.g., in order to reduce latency). An issue may arise if the WTRU misses and/or doesn't receive the carrier switching indication. In such a case, the only solution to such a problem would be for the base station (e.g., gNB) to blind detect over two carriers (e.g., or more) to determine which carrier is used by the WTRU to send the uplink transmission, which may add more latency from a network perspective. Additionally, the base station may need to blind detect the UCI size sent by the WTRU in case there is a mismatch. Furthermore, additional bits in the DCI may be needed to indicate the uplink carrier, which may not be suitable for URLLC type of service since the reliability of the DCI may be impacted (e.g., and consequently TB(s) may not be received, such as the physical downlink shared channel (PDSCH) transmission).

Accordingly, there is a need for one or more dynamic and robust uplink carrier switching mechanisms in order to achieve a desired latency target (e.g., URLLC type of service). This issue, and others, may be addressed herein by techniques related to robust dynamic uplink carrier switching, and/or reducing the probability of an error concerning an uplink carrier switching command.

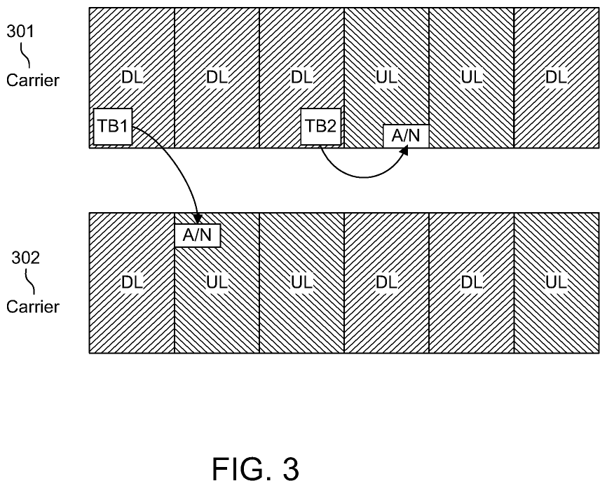

FIG. 3 illustrates an example of uplink carrier switching. In such an example, there may be PUCCH carrier switching for HARQ-ACK transmission. A WTRU may be configured with two uplink carriers (e.g., carrier 301 and carrier 302) for PUCCH transmission(s) that may carry uplink control information (UCI) related to the same serving downlink carrier(s). Generally, for a two-carrier scenario, a PDSCH transmission may be acknowledged (e.g., ACK or NACK transmission) using PUCCH transmission either on the first uplink carrier (e.g., 301) or on the second uplink carrier (e.g., 302) based on the network indication or WTRU determination. As shown in FIG. 3, the WTRU may receive a PDSCH transmission of Transport Block 1 (TB1) in the first slot of carrier 301. The WTRU may then use the second carrier 302 in the second slot to acknowledge the TB1 PDSCH transmission, since it is the first uplink opportunity between the two carriers. Later on, the WTRU may receive another PDSCH transmission TB2 in the third slot of carrier 301, and may use the fourth slot of carrier 301 to acknowledge the TB2 PDSCH transmission, since it is the first uplink opportunity. In another example not shown, a PDSCH transmission on one carrier may be acknowledged on two or more carriers.

In one case, a WTRU may switch PUCCH carrier(s) based on a PUCCH configuration. Specifically, a WTRU may be configured with a PUCCH configuration that includes PUCCH resources that belong to different uplink carriers. In one case, a WTRU may be configured with a PUCCH configuration that associates a PUCCH resource set with an uplink carrier. For example, a cell or a carrier ID may be part of the PUCCH resource set parameters. A WTRU may determine the PUCCH carrier based on the procedure of determining the PUCCH resource set to use for a PUCCH transmission. For example, the WTRU may be configured with four PUCCH resource sets: a first and second PUCCH resource sets are configured with PUCCH carrier 1, a third and fourth PUCCH resource sets are configured with PUCCH carrier 2. When the WTRU determines that the first or second PUCCH resource set is to be used for UCI transmission, the WTRU uses PUCCH carrier 1. When the WTRU determines that the third or fourth PUCCH resource set is to be used for UCI transmission, then the WTRU uses PUCCH carrier 2. As discussed herein, reference to a PUCCH transmission may include UCI transmission (e.g., HARQ-ACK feedback, CSI transmission, and/or SR).

In one case, a WTRU may be configured with a PUCCH configuration that associates a PUCCH resource with an uplink carrier. For example, a carrier ID may be part of the PUCCH resource parameters. A WTRU may determine the PUCCH carrier based on the procedure of determining the PUCCH resource to use for a PUCCH transmission. For example, the WTRU may receive a DCI with scheduling information for a PDSCH transmission, and the PUCCH Resource Indication (PRI) bitfield in the DCI may indicate a PUCCH resource for HARQ-ACK feedback, which the WTRU may then use to determine to use a different uplink carrier. In one instance, the PUCCH configuration may be an RRC configuration that configured the WTRU with a set of PUCCH resources. The PRI in the DCI may dynamically indicate which PUCCH resource from the RRC configured resources to use.

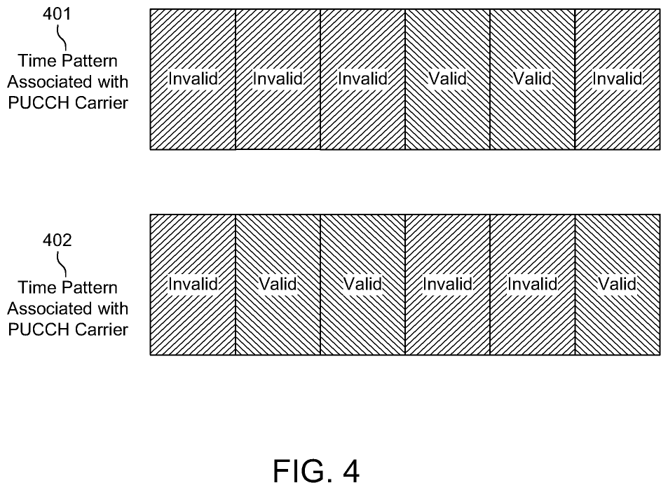

FIG. 4 illustrates an example where a PUCCH carrier is associated with a time pattern configuration. As shown, a WTRU may be configured (e.g., according to one or more techniques disclosed herein) with a PUCCH configuration that includes or is associated with a time pattern. The time pattern may be for a given interval. The time pattern and/or the given interval may be associated with a specific carrier. For example, a PUCCH configuration that has a carrier that is valid for a set of slots and/or symbols and invalid for another set of slots and/or symbols. The WTRU may be configured with more than one PUCCH configuration, where each one may be associated with a different uplink carrier and have a different time pattern configuration. For a UCI transmission (e.g., HARQ-ACK transmission) related to a downlink carrier, when transmitting the UCI related to the downlink carrier, the WTRU may select the PUCCH configuration among one or more PUCCH configurations that have a valid slot/slots/symbols at the UCI transmission time. For example, the WTRU may receive a DCI with scheduling information for a PDSCH transmission and the DCI indicates a HARQ-ACK transmission time in slot n. The WTRU may then select a PUCCH configuration that has a time pattern where there is a valid slot at the indicated UCI slot n, meaning that a PUCCH carrier is selected that has a valid/available time for the indicated slot n.

In some situations, the WTRU may be configured with a priority associated with one or more PUCCH configuration(s) in case multiple PUCCH configurations have a valid slot/symbol(s) at the indicated UCI transmission time. A WTRU may then select a PUCCH carrier from the available PUCCH configurations based on the priority of the PUCCH configuration.

In some situations, a WTRU may be configured to select the earliest PUCCH configuration with the carrier with a valid slot/symbol where there is no valid PUCCH carrier at the indicated HARQ-ACK transmission time. For example, the WTRU is configured with two PUCCH carriers with different time patterns as shown in FIG. 4 The WTRU receives a PDSCH transmission indicating a HARQ-ACK transmission time at the first slot (e.g., of any carrier). Since both carriers have invalid opportunities, the WTRU may select the second slot in 402 to transmit the HARQ-ACK feedback since it is the earliest slot available.

In one case, a WTRU may be configured to update the time pattern associated with a PUCCH carrier based on the received slot format indication (SFI) for that carrier. For example, a WTRU is configured with a first PUCCH carrier that has a valid opportunity at slot n and the WTRU receives SFI indicating that slot n is changed to a downlink slot for the first PUCCH carrier. The WTRU may consider the first PUCCH carrier as invalid at slot n. In another example, the WTRU may be configured to an invalid time opportunity at slot n and the WTRU receives SFI indicating that slot n is changed to an uplink slot for the first PUCCH carrier, thereby making it a valid time opportunity. In some situations, a WTRU may be configured to update the time pattern associated with a PUCCH carrier when a flexible slot(s)/symbol(s) is changed to uplink or downlink slot(s)/symbol(s).

In one or more cases, an indication for PUCCH carrier switching may be carried out using one or more HARQ timing indication(s). In one case, a WTRU may be assigned PUCCH resources on multiple carriers. In one situation, a WTRU may be assigned a set of PUCCH resources on a set of uplink carriers associated with a downlink carrier. Additionally/alternatively, there may be one or more carriers on which a DL transmission can be received that is associated with a set of PUCCH carriers. Feedback for data received on the downlink carrier may be transmitted in one or more of the PUCCH resources on one or more uplink carriers associated with the downlink carrier.

In one case, a PUCCH resource or a PUCCH carrier may be configured with a priority. A WTRU may report UCI on in a PUCCH transmission if the PUCCH resource or carrier is of the same priority as the UCI or of higher or lower priority as the UCI.

In one case a PUCCH resource may be identified by a PUCCH index and/or a carrier index. In another case all PUCCH resources on all carriers may have independent indices and a PUCCH resource may be identified by a single PUCCH index.

In one case, a WTRU may receive an indication in a scheduling DCI of the PUCCH resource and carrier on which the WTRU may report HARQ-ACK for a scheduled PDSCH. For semi-persistent scheduling (SPS), the WTRU may receive an indication in the DCI activating an SPS resource. The WTRU may determine the one or more PUCCH resources on the one or more carriers where the WTRU may report the HARQ-ACK for the SPS activation or the SPS PDSCH, in the SPS activation DCI.

In one case, a WTRU may determine the PUCCH resource and carrier based on the PDSCH-to-HARQ timing indication. The timing indication may be in terms of slots or symbols and may be valid for all the associated PUCCH carriers. The WTRU may determine the PUCCH resource as the one on any of the associated carriers that satisfies the timeline of the PDSCH-to-HARQ indication. In an example, the WTRU may select the first PUCCH resource on any of the associated PUCCH carriers, that occurs after the PDSCH-to-HARQ time has elapsed.

In one or more cases, carriers may have different numerologies. Different carriers may use different numerologies (e.g., SCS or symbol duration). The PDSCH-to-HARQ timing indication may be interpreted as using the symbol or slot duration of at least one of: the scheduling carrier (e.g., the carrier on which the WTRU received the DCI triggering a HARQ-ACK feedback report); and/or, the carrier on which the PDSCH is received or the carrier on which the PUCCH is to be transmitted. For example, when the PUCCH carrier is indicated in a DCI, the WTRU may interpret the PDSCH-to-HARQ timing indication as using the symbol or slot duration of the PUCCH carrier. In another example, when the WTRU determines the PUCCH carrier as the first carrier that satisfies the PDSCH-to-HARQ timeline, the PDSCH-to-HARQ timing indication may be interpreted as using a fixed symbol or slot duration for all PUCCH carriers (e.g., the same as that of the scheduling or scheduled downlink cell).

In one or more cases, multiple overlapping PUCCH resources may be used. A WTRU may be configured with multiple PUCCH resources in multiple carriers occurring in the same slot, symbol, and/or time. In such a case, the PDSCH-to-HARQ timing indication may be satisfied by multiple PUCCH resources on multiple carriers. In such a case, the WTRU may determine the PUCCH resource or carrier on which to report feedback by using one or more criteria as described herein.

For one criterion, the WTRU may determine the PUCCH resource or carrier on which to report feedback by using the priority of the feedback. For example, a WTRU may determine the PUCCH resource or carrier as a function of the priority of the feedback. If a feedback report contains multiple reports of multiple priorities, the WTRU may determine the appropriate PUCCH resource or carrier as a function of the maximum or minimum or average priority of the feedback report.

For one criterion, the WTRU may determine the PUCCH resource or carrier on which to report feedback by using the priority of the PUCCH resource or carrier.

For one criterion, the WTRU may determine the PUCCH resource or carrier on which to report feedback by using whether a flexible symbol has been dynamically switched to downlink or uplink.

For one criterion, the WTRU may determine the PUCCH resource or carrier on which to report feedback by using the index of the PUCCH resource or carrier. For example, the WTRU may select the PUCCH resource or carrier with the highest or lowest index value.

For one criterion, the WTRU may determine the PUCCH resource or carrier on which to report feedback by using the active BWP. For example, a WTRU may transmit feedback only if an active BWP is or is not the initial or default BWP.

For one criterion, the WTRU may determine the PUCCH resource or carrier on which to report feedback by using the LBT outcome. For example, the WTRU may select a PUCCH resource or carrier if the LBT has succeeded for the resources of the PUCCH or for the resources of the carrier.

For one criterion, the WTRU may determine the PUCCH resource or carrier on which to report feedback by using the uplink cancellation indication. For example, a WTRU may not select a PUCCH resource or carrier if it has received uplink CI overlapping the resources of the PUCCH.

For one criterion, the WTRU may determine the PUCCH resource or carrier on which to report feedback by using the PUCCH format. For example, a WTRU may select a PUCCH resource or carrier based on the PUCCH format of the available resource on the carrier.

For one criterion, the WTRU may determine the PUCCH resource or carrier on which to report feedback by using the Payload size of the feedback.

For one criterion, the WTRU may determine the PUCCH resource or carrier on which to report feedback by using the codebook type. For example, the WTRU may determine a PUCCH resource or carrier on which to report feedback based on whether the HARQ-ACK feedback codebook is type 1, 2, or 3.

For one criterion, the WTRU may determine the PUCCH resource or carrier on which to report feedback by using the codebook index. For example, a WTRU may maintain a set of codebooks. The WTRU may select the PUCCH resource or carrier as a function of the identity of the codebook(s) that the WTRU reports.

For one criterion, the WTRU may determine the PUCCH resource or carrier on which to report feedback by using the transmission power requirements. For example, a WTRU may not select a carrier if the carrier is power limited and may not achieve the required power for the transmission of the PUCCH. In another example, a WTRU may select a PUCCH carrier that requires the least amount of PUCCH transmission power.

In one or more cases, feedback may be segmented. For instance, a WTRU may segment feedback such that it uses multiple PUCCH resources, possibly overlapping, and/or possibly on multiple carriers. The WTRU may select the set of PUCCH resources or carriers using similar rules/parameters/criteria as those presented herein for the selection of a single PUCCH resource or carrier.

In an example, a WTRU may be configured with allowed pairs of carriers on which it may transmit simultaneous uplink transmission (e.g., PUCCH transmission). PUCCH transmissions may be considered simultaneous if they occur in the same set of symbols or slots or if they partially overlap in the same symbols or slots (e.g., on different carriers).

Feedback segmentation may be used if the payload is greater than a threshold. The threshold may depend on the PUCCH formats of one or more PUCCH resources on one or more carriers. Feedback segmentation may be used if multiple priorities of feedback need to be reported. In such a case, each segment may be reserved for feedback of a single or subset of priority(ies).

Feedback segmentation may be used if a WTRU is power limited on at least one of the PUCCH carriers. In such a case, the WTRU may transmit the highest priority feedback on the PUCCH carrier that is the least power limited.

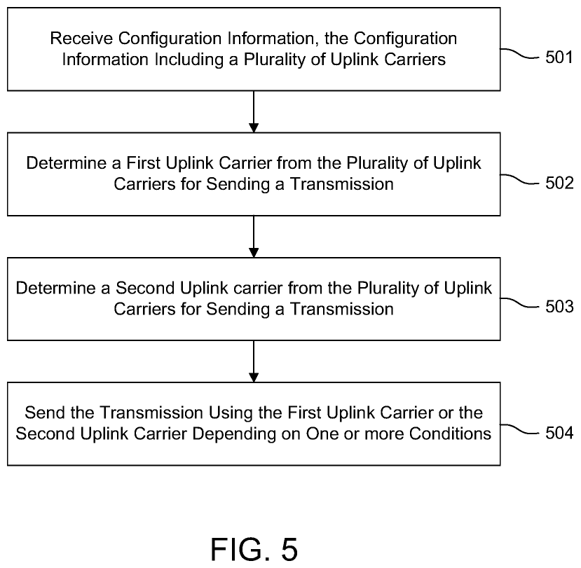

FIG. 5 illustrates an example of switching uplink carriers based on a condition. As shown, at 501 a WTRU may receive configuration information. The configuration information may include a plurality of uplink carriers. At 502 the WTRU may determine to use a first uplink carrier from the plurality of uplink carriers for sending a transmission. At 503, the WTRU may determine a second uplink carrier from the plurality of uplink carriers for sending a transmission. At 504, the WTRU may send the transmission using the first uplink carrier or the second uplink carrier depending on one or more conditions. In some situations, the determination of the first uplink carrier and/or the second uplink carrier may be dependent on a previously received transmission (e.g., configuration information, control information, transport block, transport block related information, downlink information, etc.). The condition for using the first uplink carrier or the second uplink carrier may depend on a number of factors, such as the radio conditions, the availability of resources on each carrier, an indication from the network, and/or other related information (e.g., as described herein). Additionally, the WTRU may determine the first uplink carrier and or the second uplink carrier based on one or more parameters described herein (e.g., configuration information, control information, transport block, transport block related information, downlink information, the radio conditions, the availability of resources on each carrier, an indication from the network, and/or other related information etc.).

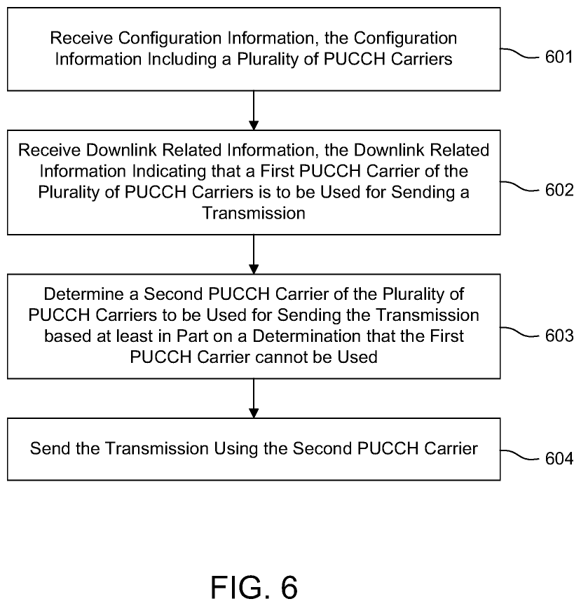

FIG. 6 illustrates an example of switching uplink carriers based on a condition. As shown, at 601 a WTRU may receive configuration information. The configuration information may include a plurality of PUCCH carriers. At 602, the WTRU may receive downlink related information. The downlink related information may indicate that a first PUCCH carrier of the plurality of PUCCH carriers is to be used for sending a transmission. At 602, the WTRU may determine a second PUCCH carrier of the plurality of PUCCH carriers to be used for sending the transmission based at least in part on a determination that the first PUCCH carrier cannot be used. At 604, the WTRU may send the transmission using the second PUCCH carrier.

In one or more cases, PUCCH carrier switching may be based one or more dropping/cancellation situations/indications. The WTRU may have a UCI transmission in a first PUCCH carrier. The WTRU may determine, based on the TDD configuration, that the UCI transmission is not possible in the first PUCCH carrier. For example, the transmission time of the UCI is configured in a downlink slot/symbols or FL slot/symbols which is flipped to downlink slot/symbol using the dynamic slot format indication. The WTRU may be configured to select a different PUCCH carrier to transmit the UCI when TDD configuration of the first PUCCH carrier does not have an available opportunity for UCI transmission. In one case, the WTRU may be configured semi-statically from a network node (e.g., gNB) with a PUCCH carrier to transmit a dropped UCI due to TDD (re)configuration. For example, an uplink carrier configuration may include a PUCCH configuration for a dropped UCI due to TDD (re)configuration. The WTRU may use the PUCCH resource indication (PRI) that was configured for the first PUCCH carrier to determine the PUCCH resource on the PUCCH carrier to transmit a dropped UCI due to TDD (re)configuration. For example, the same PRI may be used to determine the PUCCH resource on the PUCCH carrier for a dropped UCI. When the WTRU is configured with downlink SPS transmissions and the configured HARQ-ACK timing occurs in invalid slot/symbols, the WTRU may use a different PUCCH carrier to transmit the HARQ-ACK of the downlink SPS transmissions.

The WTRU may have a UCI transmission in a first PUCCH carrier. The WTRU may determine, based on a received uplink cancellation indication, that the UCI transmission is not possible in the first PUCCH carrier. For example, the WTRU receives a DCI indicating that the configured UCI transmission is to be canceled due to a higher priority transmission being scheduled for another WTRU. The WTRU may be configured to select a different PUCCH carrier to transmit the UCI when an uplink canceling indication is received. In one case, the WTRU may be configured semi-statically from a network node (e.g., gNB) with a PUCCH carrier to transmit a canceled UCI when the WTRU receives an uplink canceling indication. For example, an uplink carrier configuration may include a PUCCH configuration for a dropped UCI due to TDD (re)configuration. The WTRU may use the PUCCH resource indication (PRI) that was configured for the first PUCCH carrier to determine the PUCCH resource on the PUCCH carrier to transmit a dropped UCI due to TDD (re)configuration. For example, the same PRI may be used to determine the PUCCH resource on the PUCCH carrier for a dropped UCI.

The WTRU may have a first UCI transmission in a first PUCCH carrier and have a second UCI overlapping with the first UCI. The WTRU may determine, based on the priority of the overlapping UCIs, to drop the first UCI. The WTRU may be configured to select a different PUCCH carrier to transmit the first UCI when dropping occurs. In one case, the WTRU may be configured semi-statically from a network node (e.g., gNB) with a PUCCH carrier to transmit a dropped UCI due to prioritization. For example, an uplink carrier configuration may include a PUCCH configuration for a dropped UCI. The WTRU may use the PUCCH resource indication (PRI) that was configured for the first PUCCH carrier to determine the PUCCH resource on the PUCCH carrier to transmit a dropped UCI. For example, the same PRI may be used to determine the PUCCH resource on the PUCCH carrier for a dropped UCI. The WTRU may be configured with a high priority HARQ-ACK codebook and low priority HARQ-ACK codebook. When the low priority HARQ-ACK codebook overlaps with high priority HARQ-ACK codebook, the WTRU may use the pre-configured PUCCH carrier to transmit the low priority HARQ-ACK codebook.

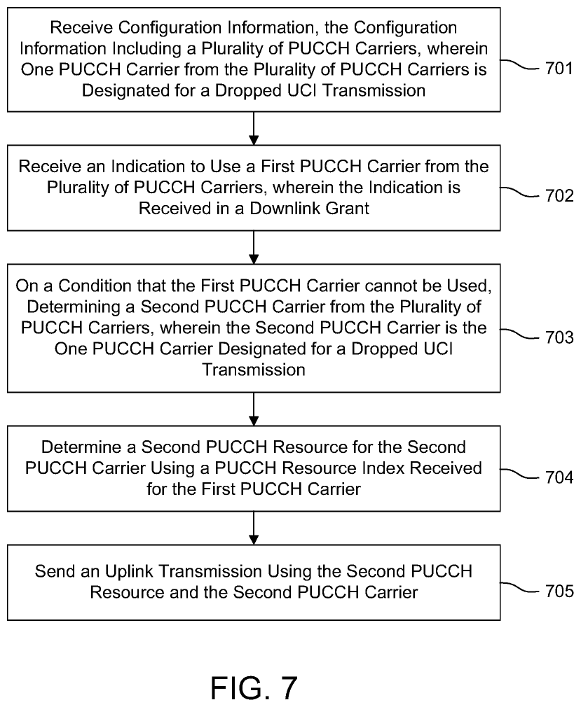

FIG. 7 illustrates an example of switching uplink carriers based on a dropping/cancellation. At 701, a WTRU may receive configuration information, the configuration information including a plurality of PUCCH carriers. In some situations, one PUCCH carriers from the plurality of PUCCH carriers may be designated for a dropped UCI transmission. At 702, the WTRU may receive an indication to use a first PUCCH carrier from the plurality of PUCCH carriers. The indication may be received in a downlink grant, as disclosed herein. At 703, the WTRU may determine a second PUCCH carrier from the plurality of PUCCH carriers. The WTRU may determine the second PUCCH carrier based on a condition that the first PUCCH carrier cannot be used, meaning that the UCI transmission may be or need to be dropped. In some situations, there may be a specific reason why the first PUCCH carrier cannot be used, and the specific reason may serve as the basis for determining the second PUCCH carrier. For example, a specific reason/condition may include: uplink cancelation priorities another uplink transmission on the first PUCCH carrier; and/or, a slot format reconfiguration changes that slot validity on the first carrier. In some situations, the second PUCCH carrier may be determined based on selecting a PUCCH carrier that has been designated (e.g., in the configuration information) for a dropped UCI transmission. At 704, the WTRU may determine a second PUCCH resource for the second PUCCH carrier using a technique described herein (e.g., using a PUCCH resource index received for the first PUCCH carrier). At 705, the WTRU may send an uplink transmission (e.g., UCI) using the second PUCCH resource and the second PUCCH carrier.

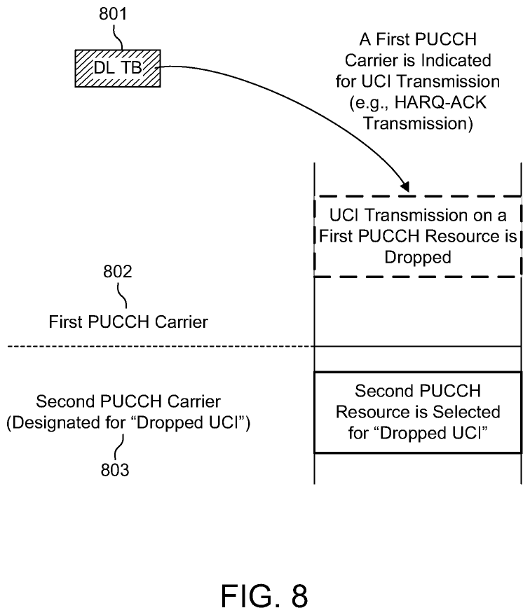

FIG. 8 is a diagram illustrating an example of switching carriers. According to one or more techniques described herein (e.g., FIG. 6, 7, or 8), a WTRU may be configured with multiple PUCCH carriers for PUCCH carrier switching. In some cases, at least one of the multiple PUCCH carriers may be designated for “dropped UCI” transmission. For example, the WTRU may drop UCI if the WTRU receives an uplink cancellation that prioritizes another uplink transmission on the first PUCCH carrier. In another example, the WTRU may receive a slot format reconfiguration that changes the slot validity of the first PUCCH carrier, and the WTRU then drops the UCI.

As shown in FIG. 8, a WTRU may be (pre)configured with a first PUCCH carrier 802. The first PUCCH carrier 802 may be determined/indicated for a UCI transmission (e.g., HARQ-ACK transmission), by a base station (e.g., gNB). The WTRU may be indicated by a base station (e.g., gNB) to use a first PUCCH resource within the first PUCCH carrier 802 for HARQ-ACK feedback transmission corresponding to a downlink TB. The WTRU may receive the downlink transmission of the TB (e.g., DL TB 801). After receiving the downlink DL TB 801, a UCI drop condition is met for the first PUCCH carrier 802 and the WTRU may determine a second PUCCH carrier 803 where the second PUCCH carrier 803 may be a PUCCH carrier designated for “dropped UCI”. The WTRU may use the PUCCH resource index received for the first PUCCH carrier 802 to determine a second PUCCH resource on the second PUCCH carrier 803. The WTRU may transmit the UCI on the second PUCCH resource in the second PUCCH carrier 803.

In one or more cases, PUCCH carrier switching may be based on downlink control channel configuration. The WTRU may be configured with a downlink carrier that is linked to multiple PUCCH carriers. The WTRU may determine which PUCCH carrier to use for UCI transmission based on the downlink control channel that the DCI triggering the UCI transmission is received. The UCI transmission may be a HARQ-ACK transmission or CSI report. The DCI triggering UCI transmission may be one of the following: a DCI scheduling a PDSCH transmission; a DCI activating or releasing a downlink SPS transmission; and/or, a DCI triggering periodic or a-periodic CSI transmission.

The WTRU may be configured to associate a downlink control channel with a PUCCH carrier. In one case, a WTRU may be configured to associate a search space/CORESET with a PUCCH carrier. The search space/CORESET configuration may include a PUCCH carrier parameter that indicates the uplink carrier/cell ID, or the PUCCH carrier configuration may include a search space/CORESET index of a downlink carrier. For example, a WTRU may be configured with a downlink carrier that has two search spaces configured: A first search space is associated with a first PUCCH carrier, and a second search space is associated with a second PUCCH carrier. When the WTRU receives a DCI in the first search space scheduling a PDSCH or activating/releasing a downlink SPS, the WTRU may transmit the HARQ ACK feedback on the first PUCCH carrier. When the WTRU receives a DCI in the second search space scheduling a PDSCH or activating/releasing a downlink SPS, the WTRU may transmit the HARQ-ACK feedback on the second PUCCH carrier. In another example, a WTRU may be configured with a downlink carrier that has two CORESETs configured: A first CORESET is associated with a first PUCCH carrier, and a second CORESET is associated with a second PUCCH carrier. When the WTRU receives a DCI in the first CORESET scheduling a PDSCH or activating/releasing a downlink SPS, the WTRU may transmit the HARQ ACK feedback on the first PUCCH carrier. When the WTRU receives a DCI in the second CORESET scheduling a PDSCH or activating/releasing a downlink SPS, the WTRU may transmit the HARQ-ACK feedback on the second PUCCH carrier.

In another case, a WTRU may be configured to associate a DCI format/size/RNTI with a PUCCH carrier. For example, a WTRU may be configured with a downlink carrier with a control channel that may schedule using two DCI formats/sizes/RNTIs: A first DCI format/size/RNTI is associated with a first PUCCH carrier, and a second DCI format/size/RNTI is associated with a second PUCCH carrier. When the WTRU receives a PDSCH scheduling or a downlink SPS activation/release using a first DCI format/size/RNTI, the WTRU may transmit the HARQ ACK feedback on the first PUCCH carrier. When the WTRU receives a PDSCH scheduling or a downlink SPS activation/release using a second DCI format/size/RNTI, the WTRU may transmit the HARQ ACK feedback on the second PUCCH carrier.

In one or more cases, power control parameters may be associated with and/or used in conjunction with carrier switching. In some cases, a WTRU may be configured to select power control parameters for a PUCCH transmission based on the indicated/selected PUCCH carrier. For example, in closed loop power control, the Transmit Power Command (TPC) indication in the DCI may be interpreted differently by the WTRU depending on which carrier the WTRU selected or which PUCCH carrier the network indicated.

In one or more cases, carrier switching may be based on HARQ-ACK codebook. In some cases, a WTRU may be configured to associate a HARQ-ACK codebook with a PUCCH carrier. For example, a WTRU may support simultaneously multiple HARQ-ACK codebooks with different indices/priorities. The WTRU may be configured to associate a HARQ-ACK codebook index with a PUCCH carrier. Such association may be semi-statically configured from the network node (e.g., gNB, such as by using RRC) or dynamically indicated (e.g., using the methods described herein). In one case, a WTRU may be configured to receive the same PUCCH carrier indication across the DCIs scheduling a PDSCHs to be acknowledged on the same HARQ-ACK codebook index (e.g., all PDSCH transmissions associated with a certain HARQ-ACK codebook may be indicated by the gNB with the same PUCCH carrier). In another case, a WTRU may be configured to receive different PUCCH carrier indications across the DCIs scheduling the PDSCHs to be acknowledged on the same HARQ-ACK codebook index. For example, for high priority HARQ-ACK codebook transmission, a WTRU may be indicated with a first PUCCH carrier using a first DCI and with a second PUCCH carrier using a second DCI; the WTRU may use the last indicated PUCCH carrier to transmit the HARQ-ACK codebook.

In one or more cases, a WTRU may autonomously select a carrier amongst a plurality of carriers. A WTRU may be configured with a set of (e.g., PUCCH) carriers. The WTRU may receive an indication to determine one or more sets of carriers over which the PUCCH resources are active. Such an indication may be received via DCI, MAC CE, and/or RRC configuration.

A WTRU may be configured with a primary PUCCH carrier and one or more secondary PUCCH carriers. The primary PUCCH carrier may be (re)configured by a network node (e.g., gNB) or may be selected by the WTRU. If the WTRU selects the primary PUCCH carrier, the WTRU may indicate the selection to the network node when it changes primary carriers.

A WTRU may be expected to transmit PUCCH feedback on a primary PUCCH carrier. In some cases, the WTRU may transmit PUCCH feedback on one or more secondary PUCCH carriers, possibly in conjunction with a PUCCH transmission on the primary PUCCH carrier.

The WTRU may select the PUCCH carrier on which to transmit feedback as a function of at least one or more factors.

For example, a WTRU may select the PUCCH carrier on which to transmit feedback as a function of the timing of PUCCH resource on a carrier. For example, the WTRU may select a PUCCH resource on a PUCCH carrier based on the time/timing of the resource(s).

For example, a WTRU may select the PUCCH carrier on which to transmit feedback as a function of the TDD configuration of a carrier. For example, the WTRU may select a PUCCH resource on a PUCCH carrier based on the number of uplink or downlink slots/symbols. In another example, a WTRU may select a PUCCH carrier based on whether the upcoming PUCCH resource on the carrier is available or if the symbol(s) have been switched to downlink symbols.

For example, a WTRU may select the PUCCH carrier on which to transmit feedback as a function of the LBT outcome. For example, a WTRU may transmit PUCCH on a secondary PUCCH carrier if LBT failed for a transmission on a primary PUCCH carrier.

For example, a WTRU may select the PUCCH carrier on which to transmit feedback as a function of the payload size. For example, the WTRU may transmit PUCCH on a primary/secondary carrier(s) if its payload is greater than or less than a threshold value.

For example, a WTRU may select the PUCCH carrier on which to transmit feedback as a function of the uplink cancellation indication. For example, a WTRU may send a PUCCH transmission on a secondary PUCCH carrier if it has received uplink CI in the primary PUCCH carrier indicating that the PUCCH resources are not available.

For example, a WTRU may select the PUCCH carrier on which to transmit feedback as a function of whether simultaneous PUSCH-PUCCH transmissions are possible.

For example, a WTRU may select the PUCCH carrier on which to transmit feedback as a function of the whether the WTRU is scheduled with PUSCH transmissions. For example, a WTRU may select a secondary PUCCH carrier if it is not scheduled with a PUSCH transmission on the PUCCH resources such that it need not send transmissions for PUCCH-PUSCH simultaneously on the carrier.

For example, a WTRU may select the PUCCH carrier on which to transmit feedback as a function of the power requirements. For example, a WTRU may select a PUCCH carrier based on the power requirements. For example, the WTRU may select a PUCCH carrier that is the least power limited.

For example, a WTRU may select the PUCCH carrier on which to transmit feedback as a function of the priority of feedback. For example, a WTRU may be configured with one or more applicable PUCCH carriers for each feedback priority.

For example, a WTRU may select the PUCCH carrier on which to transmit feedback as a function of the PUCCH Format.

For example, a WTRU may select the PUCCH carrier on which to transmit feedback as a function of the PUCCH resource parameters. For example, the number of symbols of a PUCCH resource.

In one or more cases, there may be PUCCH transmission which is a retransmission. A WTRU may transmit PUCCH feedback on a first PUCCH resource on a first PUCCH carrier and may retransmit the PUCCH feedback on a second PUCCH resource on a second PUCCH carrier. Note that the first and second PUCCH resource/carrier may be the same or different depending on factors and considerations described herein.

In some cases, for retransmission, a WTRU may select the set of PUCCH resources or PUCCH carriers using rules described herein for the selection of a single PUCCH resource of a PUCCH carrier. The WTRU may be configured with one or more sets of PUCCH resources/carrier and may retransmit any PUCCH feedback on at least one resource of each PUCCH carrier.

In some cases, a WTRU may maintain a HARQ codebook and may transmit feedback for the HARQ codebook in a first PUCCH resource in a first PUCCH carrier. The WTRU may be scheduled with TBs whose feedback may be appended to the same HARQ codebook, for example if the WTRU doesn't receive a New Feedback Indicator (NFI). In such a case, the WTRU may transmit the new HARQ codebook (e.g., composed of previously feedback HARQ-ACK values along with new HARQ-ACK values) in a second PUCCH resource possibly in a second PUCCH carrier.

In some cases, a WTRU may autonomously retransmit a HARQ-ACK codebook. For example, a WTRU may transmit a HARQ-ACK codebook on a first PUCCH carrier (e.g., primary). If the WTRU does not receive an NFI or is not scheduled with a new TB for at least one of the HARQ Processes included in the codebook, the WTRU may retransmit the HARQ-ACK codebook in a second PUCCH carrier. The WTRU may be triggered to retransmit a HARQ-ACK codebook when a timer expires (e.g., where the timer has been configured from the network). The timer may be started upon completing the first or previous transmission of the HARQ-ACK codebook. The timer may be stopped when the WTRU receives NFI or is scheduled with a transmission of a new TB on at least one of the HARQ Processes included in the codebook.

In some cases, a WTRU may autonomously retransmit a HARQ-ACK codebook if its previous transmission failed for some reason. For example, failed due to failed LBT, failed because it was dropped due to a higher priority transmission taking precedence, and/or failed due to reception of an uplink CI. Such a retransmission may be on the same PUCCH carrier or on a different (e.g., secondary) PUCCH carrier, determined as discussed herein.

In one or more cases, a WTRU may perform uplink carrier switching for a PRACH transmission. The WTRU may be configured with one or more uplink carriers to perform PRACH transmission. The WTRU may be configured to transmit PRACH only using one carrier. Alternatively, the WTRU may be configured to transmit simultaneously multiple PRACH transmissions in different uplink carriers. The WTRU may receive the uplink carriers' configuration for random access procedures using broadcasted system information SIB or via RRC configuration. For example, a WTRU may be configured using SIB broadcasted messages with a first PRACH configuration on a first uplink carrier and a second PRACH configuration on a second uplink carrier. In some situations, the WTRU may autonomously select the uplink carrier for one or more PRACH transmissions. The WTRU may select an uplink carrier for PRACH transmission from the configured uplink carriers for PRACH based on one or more factors.

An uplink carrier selection factor may be time availability of the uplink carrier. For example, at the PRACH transmission time, an uplink carrier may not be available for uplink transmission and only available for downlink transmission. The WTRU may then select the available uplink carrier with available PRACH transmission time.

An uplink carrier selection factor may be failure to receive a random-access response (RAR) following a previous PRACH transmission(s). For example, a WTRU may select a first uplink carrier to transmit a PRACH. After selecting the uplink carrier, the WTRU may start a timer once a RACH procedure started. Upon timer expiration, if the WTRU fails to receive a RAR, the WTRU may select a second uplink carrier to transmit PRACH.

An uplink carrier selection factor may be LBT success or failure. For example, a WTRU may be configured with multiple uplink carriers for PRACH transmission. The WTRU may select the uplink carrier for PRACH transmission on the uplink carrier where LBT succeeded. If LBT succeeded in more than one uplink carrier, the WTRU may select the uplink carrier based on the uplink carrier index.

An uplink carrier selection factor may be the type of service initiating the random-access process. For example, an uplink carrier may be dedicated to a low latency type of service. Another carrier may be dedicated to a high reliability type of service. The WTRU may select the uplink carrier based on which service is initiating the random-access procedure.

An uplink carrier selection factor may be the bandwidth of the uplink carrier. For example, a WTRU may be configured to select the uplink carrier with the largest bandwidth. In another example, the WTRU may be configured to select the uplink carrier with the smallest bandwidth. In another example, the WTRU may be configured to select the uplink carrier based on a bandwidth that can handle the transmission.

An uplink carrier selection factor may be the uplink carrier index. For example, a WTRU may be configured to select an uplink carrier for PRACH transmission with the smallest index.

An uplink carrier selection factor may be WTRU capability on supporting the uplink carrier. In one example, a WTRU may select the uplink carrier with bandwidth supported by the WTRU. In another example, a WTRU may be configured to select the uplink carrier that belongs to a frequency band that the WTRU supports.

In some situations, a WTRU may be configured with one search space set to monitor the random-access response (RAR) of the PRACH transmission on different uplink carriers. For example, the WTRU may be configured using SIB broadcasted signaling with one search space set to monitor the RAR of all configured uplink carriers for PRACHs. In another approach, a WTRU may be configured with multiple search space sets where each one is associated with an uplink carrier. The WTRU may monitor the RAR of each transmitted PRACH on the corresponding search space set associated with the used uplink carrier. The search space set configuration of the random-access response may include uplink carrier index to associate the search space set with an uplink carrier.

In some situations, a WTRU may be configured to transmit a PRACH over multiple carriers. For example, part of a PRACH transmission is transmitted in one carrier and another part is transmitted in a different carrier. In a first example, a WTRU may use the same bandwidth allocation for PRACH in different carriers and transmit part of the PRACH duration in a first carrier and the remaining part of the PRACH duration in a second carrier. In another example, a WTRU may use the same duration for PRACH in different carriers and transmit part of the PRACH frequency allocation in a first carrier and the remaining part of the PRACH allocation in a second carrier.

In one example, a WTRU may be configured with multiple PUCCH carriers associated with a different time pattern having valid/invalid slot/symbols. The WTRU may determine that a PUCCH carrier can be used for a PUCCH transmission if the indicated transmission time belongs to a valid slot/symbols of the PUCCH carrier time pattern. The time pattern of a PUCCH carrier may be updated/changed by the slot format indication of that PUCCH carrier.

In one example, a WTRU may determine the PUCCH carrier to be used for HARQ-ACK transmission based on the PDSCH-to-HARQ transmission time indicated by the DCI: PDSCH-to-HARQ transmission time may indicate a PUCCH carrier with valid transmission time; and/or, in case multiple PUCCH carriers are available, the WTRU may select a PUCCH carrier with high priority.

In one example, within a carrier, a WTRU may be configured with a different search space in the same carrier associated with a different PUCCH carrier. for a DCI received in a first search space scheduling a PDSCH, the PDSCH may be acknowledged in a first PUCCH carrier; for a DCI received in a second search space scheduling a PDSCH, the PDSCH will be acknowledged in a second PUCCH carrier; and/or, a WTRU may segment the HARQ-ACK feedback and transmit it in different PUCCH carriers.

In one example, the WTRU may be configured with multiple uplink carriers to perform PRACH transmission. The WTRU may select an uplink carrier for PRACH transmission based on one or more of the following: time availability of the uplink carrier; failure to receive a random-access response (RAR) following a previous PRACH transmission(s); Listen Before Talk (LBT) success or failure; type of service initiating the random-access process; bandwidth of the uplink carrier; uplink carrier index; and/or, WTRU capability on supporting the uplink carrier.

For robust and dynamic uplink carrier switching, the WTRU may determine which carrier to use for uplink transmissions. The WTRU may determine which carrier to use for uplink transmission based on one or more instances/factors.

In an example, the WTRU may determine which carrier to use for PUCCH based on separate PUCCH configuration, each for a different carrier in conjunction with a configured time pattern.

In an example, the WTRU may determine which carrier to use for PUCCH based on PDSCH-to-HARQ timing indication, where the PDSCH-to-HARQ indication may point to the first available PUCCH carrier so that the WTRU selects a PUCCH cell that has an uplink slot/enough symbols available at the HARQ-ACK transmission time, where: a set of PUCCH carriers may be associated with a downlink cell; each PUCCH carrier may have a priority index; and/or, in case of multiple available PUCCH carriers, WTRU selects the high priority carrier.

In an example, the WTRU may determine which carrier to use for PUCCH based on PUCCH carrier switching in case UCI dropping occurs. For example, the WTRU may drop a HARQ-ACK transmission due to unavailable uplink on the PUCCH carrier or overlapping with high priority UCI, where the WTRU then uses a second PUCCH carrier.

In an example, the WTRU may determine which carrier to use for PUCCH based on the search space on which the scheduling DCI is received, where a search space set may be associated with a PUCCH carrier.

For reducing the probability of misdetection of PUCCH carrier switching command, on top of a possible dynamic indication, the WTRU may be configured with one or more rules to reduce the probability of misinterpretation of the carrier to be used for PUCCH transmission.

In an example, one rule for reducing the probability of an error related to the PUCCH carrier switching command may be that the WTRU does not apply PUCCH carrier switching across HARQ-ACK codebooks (e.g., all downlink transmissions associated with a certain HARQ-ACK codebook is indicated with the same PUCCH carrier).

In an example, one rule for reducing the probability of an error related to the PUCCH carrier switching command may be that PUCCH carrier switching may be allowed only for the transmission of high priority HARQ-ACK codebook/UCI. For high priority HARQ-ACK codebook transmission, a WTRU may be indicated to change the PUCCH cell.

In an example, one rule for reducing the probability of an error related to the PUCCH carrier switching command may be that a first PUCCH carrier is used as a “main” PUCCH carrier and a second PUCCH carrier is used as “backup” PUCCH carrier: Such a case may depend on the payload of HARQ-ACK codebook (e.g., if the size is small then from gNB perspective it may blind detect over different carriers), and/or mapping a HARQ-ACK codebook to PUCCH cell that has more uplink resource and/or flexible resources.

In an example, one rule for reducing the probability of an error related to the PUCCH carrier switching command may be that the WTRU transmits on a first PUCCH resource on a first PUCCH cell and (re)transmits on the second PUCCH resource on a second PUCCH cell if: the gNB doesn't send NFI; and/or, the HARQ process ID is not re-used for a different TB after X slot(s).

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., with respect to a specific example, embodiment, figure, etc.), one of ordinary skill in the art will appreciate that each feature or element described herein may be used alone or in any combination with any other features and elements described herein. For example, a step from a method described with respect to one figure may be used with another step from a different figure. For example, multiple steps from a method may be used with multiple steps from another method. For example, some steps of a disclosed method may be optional, and others may be combined with techniques disclosed with respect to other examples. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read-only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit receive unit (WTRU), the method comprising:
receiving configuration information indicating a plurality of physical uplink control channel (PUCCH) carriers;
receiving downlink control information (DCI) indicating a PUCCH resource associated with a first PUCCH carrier of the plurality of PUCCH carriers for sending a Uplink Control Information (UCI) transmission; and
transmitting the UCI transmission on a second PUCCH carrier of the plurality of PUCCH carriers, wherein the second PUCCH carrier is selected based on an indication of cancelation for the UCI of the first PUCCH carrier.

2. The method of claim 1, wherein the second PUCCH carrier is designated for a cancelled UCI transmission.

3. The method of claim 1, wherein the second PUCCH carrier is designated as a secondary carrier and the first PUCCH carrier is designated as a primary carrier.

4. The method of claim 1, wherein the UCI transmission is for feedback for a previously received physical downlink shared channel transmission of a first transport block.

5. The method of claim 1, wherein the PUCCH resource on the first PUCCH carrier of the plurality of carriers is used to determine another resource on the second PUCCH carrier for the UCI transmission, wherein the indication of cancellation further includes an indication that prioritizes another transmission over the UCI on the first PUCCH carrier.

6. The method of claim 1, wherein the indication of cancellation is received in a slot format reconfiguration, wherein the slot format indication makes a slot of the PUCCH resource for the first PUCCH carrier invalid for uplink transmission.

7. The method of claim 1, wherein the second PUCCH carrier is further selected based on at least one of: an index of carriers, a priority of feedback, an indicated transmission time of the UCI on the first PUCCH carrier being associated with a downlink slot, or a payload feedback size.

8. A wireless transmit receive unit (WTRU), the WTRU comprising:
a processor operatively coupled to a transceiver, the processor and transceiver configured to receive configuration information indicating a plurality of physical uplink control channel (PUCCH) carriers;
the processor and transceiver configured to receive downlink control information, indicating a PUCCH resource associated with a first PUCCH carrier of the plurality of PUCCH carriers for sending a Uplink Control Information (UCI) transmission; and
the processor and transceiver configured to transmit the UCI transmission on a second PUCCH carrier of the plurality of PUCCH carriers wherein the second PUCCH carrier is selected based on an indication of cancelation for the UCI of the first PUCCH carrier.

9. The WTRU of claim 8, wherein the second PUCCH carrier is designated for a cancelled UCI transmission.

10. The WTRU of claim 8, wherein the second PUCCH carrier is designated as a secondary carrier and the first PUCCH carrier is designated as a primary carrier.

11. The WTRU of claim 8, wherein the UCI transmission is for feedback for a previously received physical downlink shared channel transmission of a first transport block.

12. The WTRU of claim 8, wherein the PUCCH resource on the first PUCCH carrier of the plurality of carriers is used to determine another resource of the second PUCCH carrier for the UCI transmission, wherein the indication of the cancellation further includes an indication that prioritizes another transmission over the UCI on the first PUCCH carrier.

13. The WTRU of claim 8, wherein the indication of cancellation is received in a slot format reconfiguration, wherein the slot format indication makes a slot of the PUCCH resource for the first PUCCH carrier invalid for uplink transmission.

14. The WTRU of claim 8, wherein the second PUCCH carrier is further selected based on at least one of: an index of carriers, a priority of feedback, an indicated transmission time of the UCI on the first PUCCH carrier being associated with a downlink slot, or a payload feedback size.
